(19) United States
(12) Patent Application Publication
(10) Pub. No.: US 2005/0161557 A1
(43) Pub. Date: Jul. 28, 2005

(54) Laptop stand

(76) Inventor: Kevin J. Heintz, Marine City, MI (US)

Correspondence Address: KEVIN J HEINTZ, 603 N MAIN, MARING CITY, MI, 48039, US

(21) Appl. No.: 10/766,569

(22) Filed: Jan. 28, 2004

(51) Int. Cl. F16L 3/00

(52) U.S. Cl. 248/121

(57) ABSTRACT

This invention (laptop stand) is intended to solve the problem of laptop computers being moved or stolen. This invention is easy to use with a simple locking mechanism. This invention is adjustable in width so that many different sizes of laptop computers may be mounted or secured. This invention will allow the computer to be mounted/secured while in use.

My invention (laptop stand) is a device for mounting laptop computers to various work surfaces including ergonomic arms so that the laptop computer is stable and not easily moved. The device is comprised of several brackets that interlock together to secure the laptop computer by entrapping the screen portion of the laptop computer. The invention is adjustable to accommodate various widths of laptop computers. The invention will not interfere with laptop computers that utilize touch screen technology.

Entrapment brackets are designed to fit over the edges of the screen portion of the laptop computer as it is in the open position. After adjusting to the width of the laptop computer the entrapment brackets are fastened to a mounting bracket and held firmly in place with threaded fasteners. The mounting bracket with entrapment brackets in place are positioned over the screen portion of the laptop computer (in the open position) and interlocked with a mounting plate. The mounting plate can be interlocked with a desk plate that is affixed to the desk or work surface or mounted to a work surface such as a desk or even an ergonomic arm. A padlock or pin lock is then placed in pre existing holes in the mounting bracket, base plate and adhesive mat to prevent separation therefore securing the laptop computer.

### FIELD OF THE INVENTION

This invention relates to a device to mount/secure laptop computers in an open position. The device is of simple construction and can be mounted in more than one fashion.

### BACKGROUND OF THE INVENTION

Today, laptop computers are used in offices, hotels, schools, dorm rooms, hospitals and other public and private places. This invention will allow a laptop computer to be mounted in an open position to a work surface such as a desk or rolling cart and to an ergonomic arm so that the laptop will be stable and not easily moved or stolen. This invention is adjustable to accommodate various sizes of laptop computers. The invention will not block access to the screen and will not interfere with touch screen technology commonly used with computers.

### SUMMERY OF THE INVENTION

The present invention provides a simple mounting device having a base plate, a mounting bracket, entrapment brackets, a desk plate or adhesive mat, screws or threaded fasteners, and a padlock or pin lock.

The base plate is comprised of a horizontal and vertical surface. The vertical surface is at an angle less than ninety degrees to the horizontal surface with elongated slots through the face of the vertical surface. The vertical surface also has flanges perpendicular to the face of the vertical surface. These flanges have one or more holes through their surface.

The entrapment brackets have several holes or slots. These holes or slots correspond with threaded holes in the mounting bracket and allow the width of the device to be adjusted to the width of various laptop computers. The entrapment brackets are fastened to the mounting bracket using threaded fasteners.

The mounting bracket consists of a flat plate with a series of flanges bent at ninety degrees. Some of the flanges have slots that correspond with the slots in the vertical surface of the base plate and engage the mounting plate to the base plate. Some flanges have holes that correspond with holes in the mounting plate and the adhesive mat.

The adhesive mat is a flat plate with flanges bent at ninety degrees. Holes in the flanges correspond with holes in the mounting plate and the base plate.

A padlock or pin lock is positioned in pre-existing corresponding holes in the base plate, mounting plate and adhesive mat to prevent the separation of the mounting plate, base plate and adhesive mat subsequently securing the laptop computer.

### BRIEF DESCRIPTION OF THE DRAWING

FIG. 1 is an exploded view of all components of the device as they would be assembled.

FIG. 2 is a front view of the device showing the adjustability to adapt to different size laptop computers.

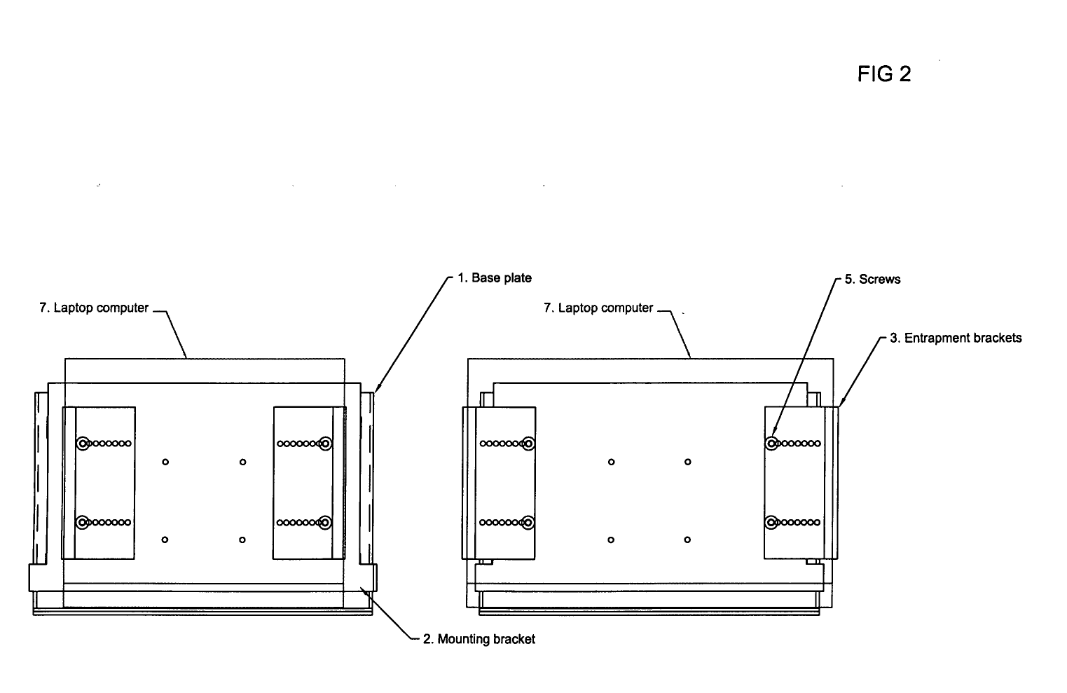

FIG. 3 shows the three views (front, top and right side) of the base plate and the slots in the face of the base plate that accept the flanges of the mounting bracket.

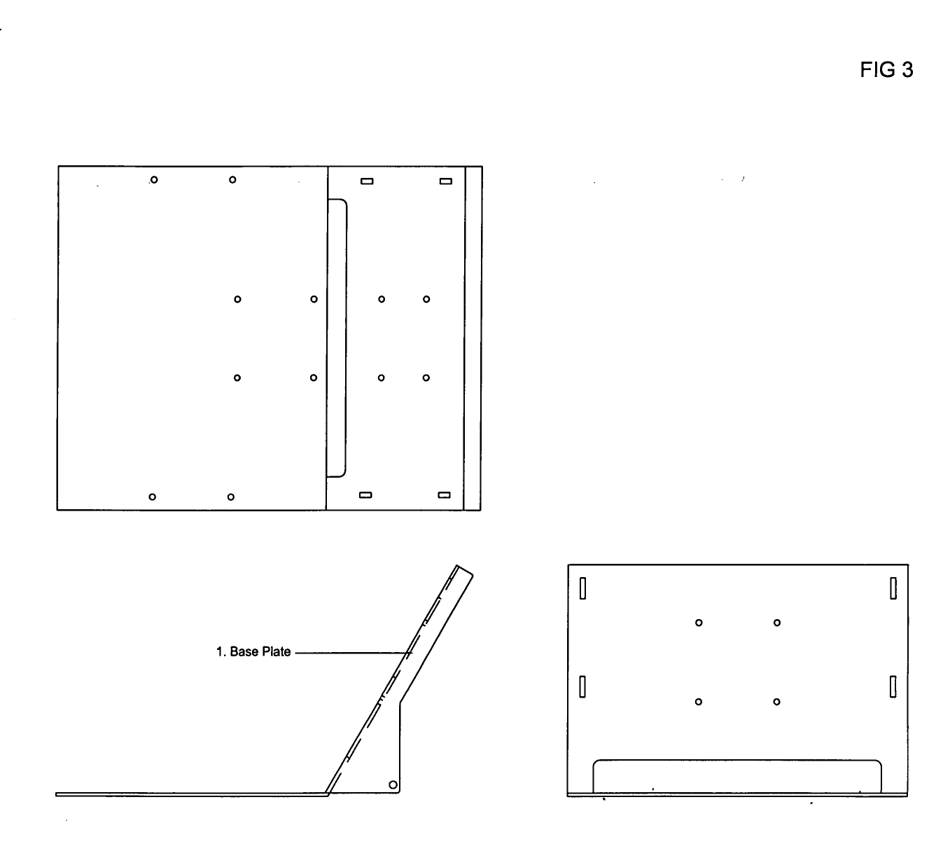

FIG. 4 is showing the front, top and right side view of the mounting bracket with the holes for accepting the screws that fasten the entrapment brackets to the mounting plate.

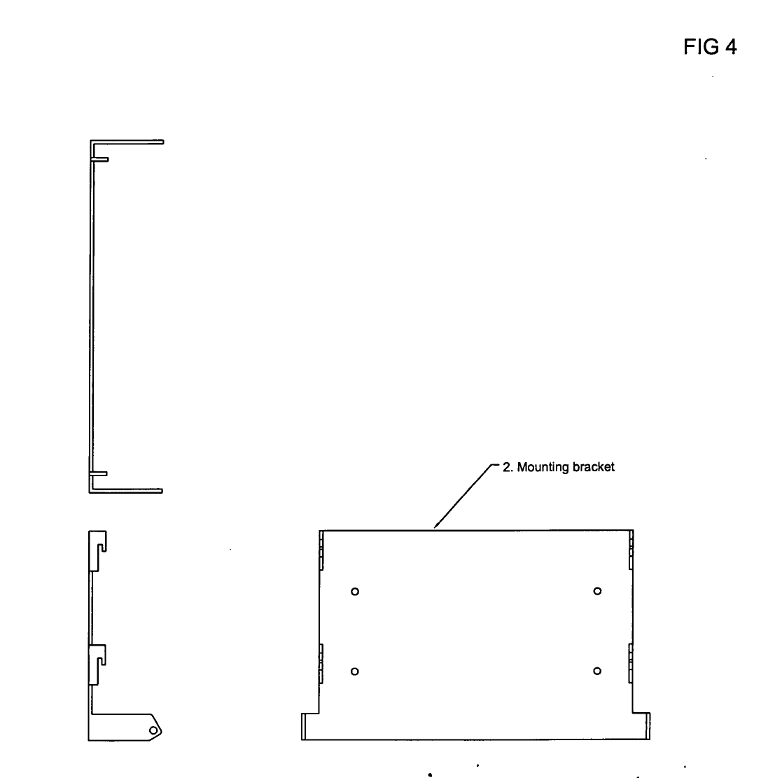

FIG. 5 shows the front, top and right side view of the entrapment brackets.

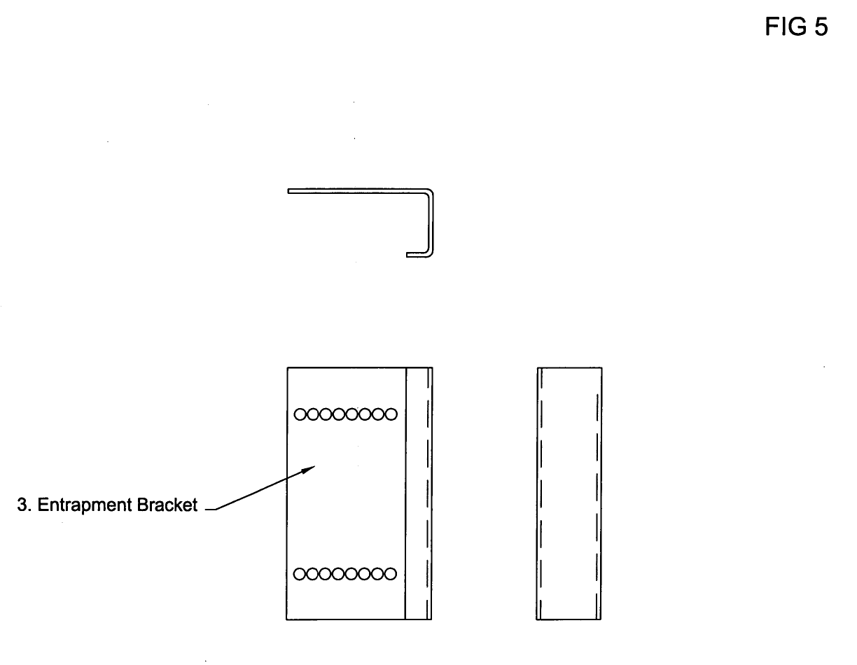

FIG. 6 shows the front, top and right side view of the adhesive mat.

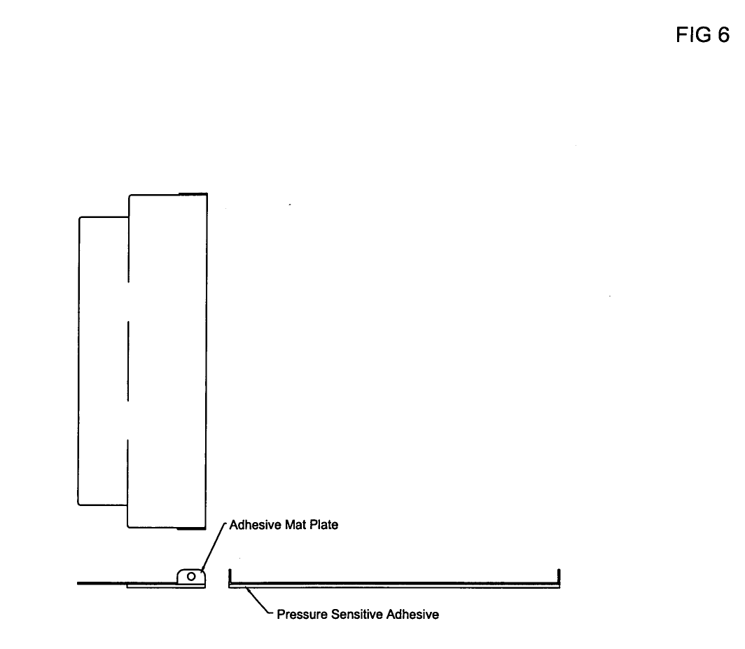

FIG. 7 is a view of the device fully assembled with a laptop computer mounted.

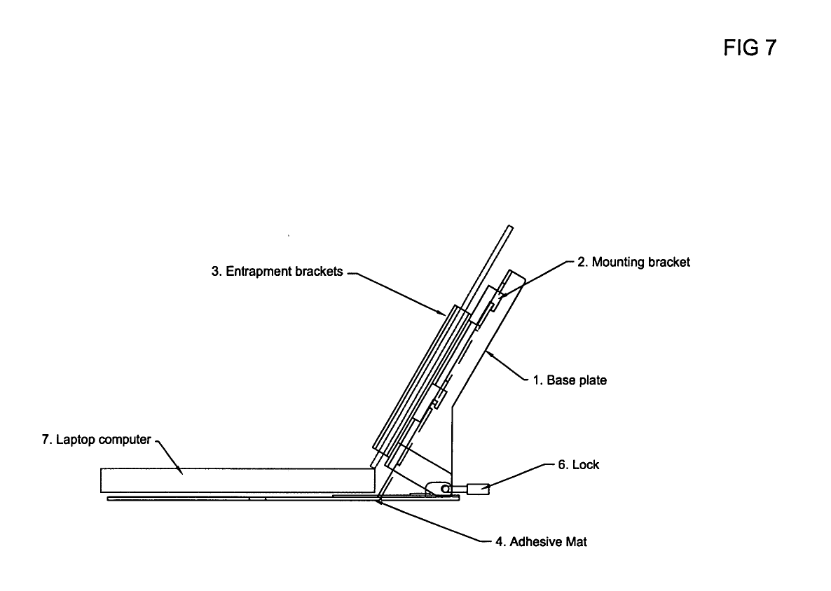

### DETAILED DESCRIPTION OF THE INVENTION

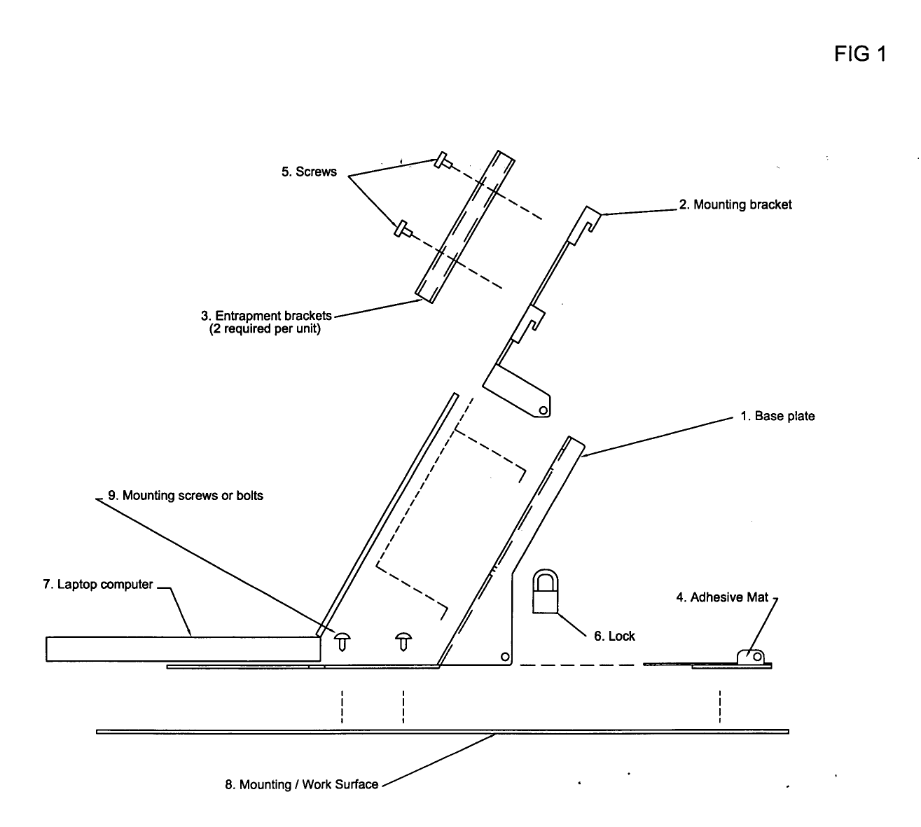

Referring now to the drawings in detail. FIG. 1 shows the device as it would be assembled. The base plate 1 may be affixed to a work surface 8, such as a desk or suitable work surface such as a desk, rolling cart or an ergonomic arm using bolts or screws 9 or by using an interlocking adhesive mat assembly 4 or a combination of the two.

Screws 5 fasten the entrapment brackets 3 to the mounting bracket 2. The mounting bracket 2 with the entrapment brackets 3 fastened in place is positioned over the screen portion of the laptop computer 7.

The flanges of the mounting bracket 2 are then aligned with the slots in the base plate 1 and engaged by inserting the flanges in to the slots and sliding the assembly downward.

Holes in a flange on the mounting bracket 2 correspond with holes in the side of the base plate 1 and with holes in the flange of the adhesive mat 4. A padlock or a pin lock 6 is inserted to prevent the mounting plate 2 from disengaging with the base plate 1 and the adhesive mat 4 if used.

1. I claim as my invention a device that will mount and secure a laptop computer to various work surfaces including but not limited to desks, rolling carts, tables and ergonomic arms. This invention will mount and secure a laptop computer so that the laptop computer is usable and in the open position. This invention is adjustable to accommodate different sizes of laptop computers and will not interfere with or block access to touch screen technology.
